(19) United States
(12) Patent Application Publication
(10) Pub. No.: US 2006/0056177 A1
(43) Pub. Date: Mar. 16, 2006

(54) Coolite

(76) Inventors: Larry L. Groth JR., Springfield, IL (US); Jan E. Baker, Springfield, IL (US)

Correspondence Address: Jan E. Baker, 4614 Peoria Rd, Springfield, IL, 62707, US

(21) Appl. No.: 10/939,171

(22) Filed: Sep. 13, 2004

(51) Int. Cl. B60Q 1/26

(52) U.S. Cl. 362/227

(57) ABSTRACT

Any insulated cooler incorporating an advantageous feature of a light that turns on automatically or manually as the cooler is opened to be named “COOLITE” by above inventors. A preferred embodiment of the cooler broadly comprises a cooler body; a cooler lid; two or more wheels or no wheels; and a possible handle. A contoured cavity on the inside of the lid or the interior of the cooler is the holding structure for the light feature. The terms “lighting unit” and “lighting fixture” are used interchangeably herein to refer to an apparatus including a light source of different types. A given lighting unit may have any one of a variety of mounting arrangements for the light source, enclosure/housing arrangement and shapes, and/or electrical and mechanical connection configurations with automatic or manual on/off switch. A given lighting unit may be associated with various other components (circuitry) relating to the operation of the light including a solar panel on the outside of the cooler lid. An LED-based unit refers to a lighting unit that includes one or more LED based light sources or in combination with other non LED based light sources.

### BACKGROUND OF THE INVENTION

1. The present invention relates to insulated coolers and similar devices for receiving and maintaining food and drink items at a temperature which is cooler than that of an ambient environment. More particularly, the present invention concerns an insulated cooler having a lid presenting a contoured cavity on the inside of the lid as the holding structure or on the interior of the cooler, for the light feature. The terms “lighting unit” and “lighting fixture” are used interchangeably herein to refer to an apparatus including a light source of different types. A given lighting unit may have any one of a variety of mounting arrangements for the light source, enclosure/housing arrangement and shapes, and/or electrical and mechanical connection configurations with automatic or manual on/off switch. A given lighting unit may be associated with various other components (circuitry) relating to the operation of the light including a solar panel on the outside of the cooler lid. An LED-based unit refers to a lighting unit that includes one or more LED based light sources or in combination with other non LED based light sources.

2. The limited functionality of prior coolers can lead to substantial inconveniences where, for example, a person on an extended outing till dark will not be able to distinguish what beverage they are pulling out of the cooler without the proper lighting. Due to the above-identified problems and disadvantages, there exists a distinct need for an improved automatic or manual lighting cooler (lights when opened).

### SUMMARY OF THE INVENTION

1. The present invention solves the above-described problem and disadvantages to provide an insulated cooler incorporating an advantageous feature of automatic or manual lighting when opened.

2. The cooler body is an insulated compartment for receiving items, such as, for example food or drink items, and to maintain those items at a relatively cool temperature for an extended period of time. A contoured cavity on the inside of the lid or the interior of the cooler is the holding structure for the invented “light feature”. A given lighting unit may have any one of a variety of mounting arrangements for the light source, enclosure/housing arrangement and shapes, and/or electrical and mechanical connection configurations with automatic or manual on/off switch. A given lighting unit may be associated with various other components (circuitry) relating to the operation of the light including a solar panel on the outside of the cooler lid. An LED-based unit refers to a lighting unit that includes one or more LED based light sources or in combination with other non LED based light sources.

Having thus described the preferred embodiment of the invention, what is claimed as new and desired to be protected by Letters Patent includes the following:

1. Any cooler comprising: a cooler body having an insulated compartment; a cooler lid adapted to cooperate with the cooler body so as to substantially seal the insulated compartment and house the automatic lighting unit.

2. The term light source should be understood to refer to any one or more of a variety of radiation sources, including but not limited to LED-based sources, solar powered sources, incandescent sources (filament lamps, halogen lamps), fluorescent sources, phosphorescent sources, high-intensity discharge sources (sodium vapor, mercury vapor, and metal halide lamps), lasers, other types of electro-luminescent sources, candle luminescent sources, photo-luminescent sources, tribo-luminescent sources, sono-luminescent sources, radio-luminescent sources and luminescent polymers.
